(19) United States
(12) Patent Application Publication
(10) Pub. No.: US 2011/0120631 A1
(43) Pub. Date: May 26, 2011

(54) METHOD FOR PRODUCING PREPREGS

(76) Inventor: Burkhard Staabs, Ottersberg (DE)

(21) Appl. No.: 12/438,439

(22) PCT Filed: Feb. 28, 2007
(86) PCT No.: PCT/EP2007/001707

§ 371 Date: May 29, 2009

(30) Foreign Application Priority Data
Aug. 23, 2006 (DE) 10 2006 039 444.5

(51) Int. Cl. B32B 38/18; B32B 38/10

(52) U.S. Cl. 156/184; 156/269

(57) ABSTRACT

The method described serves for the production of prepregs made of synthetic resin and reinforcement fibers, the prepregs having certain contours. In order to minimize scrap and waste, first molded fibrous parts (16), comprising at least one layer of reinforcement fibers, are produced, having contours which correspond to the contours of the prepregs (10) to be produced. The molded fibrous parts (16) are placed on a carrier net (12) and are impregnated with resin, which is subsequently solidified to the strength level required for the prepregs (10). The resulting prepregs (10) having the predetermined contours can then be immediately separated from the part of the carrier net that surrounds them, or can initially rolled up together with the carrier net (12), temporarily stored, and transported to the further processing location.

The invention relates to a method for producing prepregs consisting of synthetic resin and reinforcement fibers, having defined contours.

At present, many structural elements consist of fiber composites. The fibers employed here have the function of absorbing the occurring forces. The fibers are placed into the structural elements in accordance with the load lines and are maintained in their places by a resin as the matrix material. The matrix material is soft prior to curing. Therefore molds, in which the curing process can take place, are required as a rule.

In a customary production process the fibers are placed loosely into the mold and are then saturated by hand with resin (manual application process). Because of the large proportion of manual labor, this method is not only time- and cost-intensive, but also has the disadvantage that the size of the resin and fiber proportions in the finished laminate can only be constantly maintained at a preset value, if the workers performing the lamination are very experienced. In most cases these structural elements become heavier than required, or the danger of “dry spots” in the laminate, or of entrained air, arises, which can clearly weaken stability. Beginning a few years ago, attempts have been made to make the quality of such laminates more even and to improve it. One of the paths taken for this purpose proceeds by means of the so-called prepregs. Here, the reinforcement fibers are wound off storage rolls in the form of webs of material and are saturated with a special resin, mainly an epoxy resin, which is almost solid at room temperature and sets only very slowly. The prepregs are then first available in the form of rolled-up webs of material with a synthetic resin which is cured up to a defined degree of solidity. When cooled to −18° C., these prepregs can be preserved for approximately 18 months. But they can also be shipped without problems without refrigeration if further processing follows in a short while.

At the processor, the prepregs from the web of material are cut to the sizes required for the various structural elements, are then placed into the molds provided and are heated to a medium temperature in a furnace. The resin liquefies at this temperature and the various layers combine with each other. In order to prevent the entrainment of air, the structural elements are placed into a vacuum at regular intervals. Curing at still more increased temperatures follows.

In the course of cutting the prepregs to size from the web of material by the processor, 15 to 20% of waste are regularly created, which are then sorted by hand for usable pieces. The remainder must be disposed of as special waste in a cost-intensive way.

A customary installation for producing prepregs consists of an unwinding unit, an impregnating unit, possibly a drying unit (in case of using resins containing solvents), a cooling unit and a winding unit.

The fiber material is delivered in the form of large rolls and is fed to the machine through the unwinding unit. An intermediate storage device makes it possible to change rolls while the machine is running. In the course of a work shift, impregnation takes place practically uninterruptedly. Dust can be removed from the fibers, the weight per area unit can be measured.

In the impregnating unit, the fibers run through a bath of the resin, which has been given low viscosity by means of a solvent or by increased temperature, and are soaked there. The proportion of resin remaining between the fibers is set, for example, by a stripper, or by pressure rollers having controllable spacing.

The possibly present solvent is evaporated by heating in the drying unit. The amount of the heat output of the drying unit is a function of the evaporation enthalpy of the solvent used and of the speed at which the fibers pass through. The drying unit and the impregnating unit are encapsulated in order to prevent the escape of the solvent into the environment.

Directly following drying, or respectively in case of the use of resins not containing a solvent, following the impregnating process, the prepregs are cooled down in the cooling unit in order to stop the reactions which had started during heating. It is customary to let the prepregs run over cooled rollers. The weight per area unit can be measured after cooling. It is possible in this way to exactly determine the fiber content of the prepregs from a comparison of the weight per area unit prior to and after impregnation.

The web-shaped prepregs are wound into rolls in the winding unit. Here, too, an intermediate storage device is provided for being able to cut the rolls to size while the machine is running. Later, prepreg elements having the respectively desired contours are cut out of the web-shaped prepregs and are further processed.

It is the object of the invention to minimize the cost of trimming and waste, and in accordance with the invention this object is attained by means of the method characterized in claim 1.

The invention provides for the production of prepregs which are already available as pieces with defined contours during the curing of the resin after the impregnating process and which no longer need to be cut out of a prepreg web, but instead can be placed directly into the mold. In comparison with the waste of 15 to 20% which has occurred so far, a direct economical advantage arises for the processor. Since the fibers are cut prior to being soaked, the waste occurring during this process is no longer special waste, but can be resold as raw material and used.

In contrast to a conventional impregnating installation, not the reinforcement fibers in the form of webs pass through the installation, but webs of carrier net made of a suitable cost-effective material. The fiber preforms to be soaked are placed on, stapled or glued to this carrier net, and with its aid are later wound into rolls. By means of a suitable sequence of the blanks it is possible to take the processing sequence at the customer into consideration.

The novel method proposed in accordance with the invention is performed on an installation consisting of the following units: an unwinding unit for the fibers, a cutting-to-size unit for structural fiber elements, an unwinding unit for the carrier net, a pre-impregnating unit for the carrier net, a unit for bringing the structural fiber elements and the carrier net together, a drying unit for the carrier net, a cooling unit for the carrier net, an impregnating unit for the prepregs, a drying unit for the prepregs, a cooling unit for the prepregs, and a winding unit.

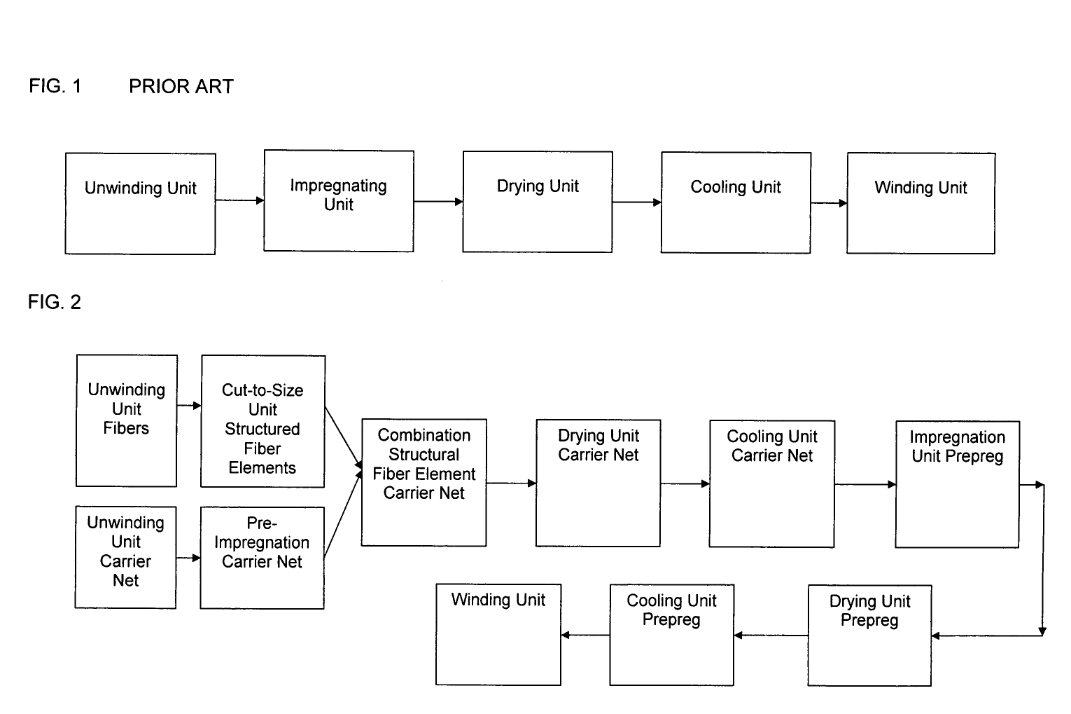

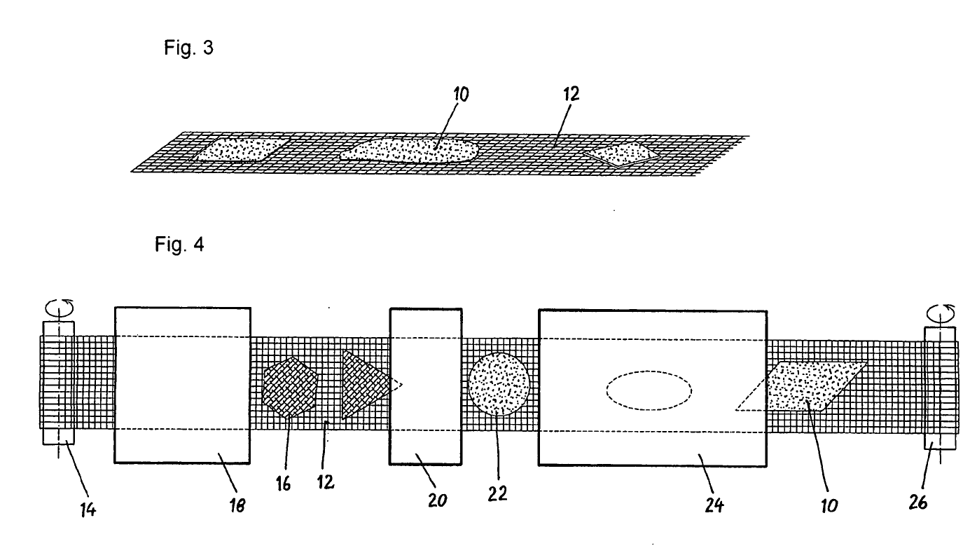

The design of the novel impregnating installation in accordance with FIG. 2 has been compared in the attached drawings with the design of a conventional impregnating unit in accordance with FIG. 1. FIG. 3 and FIG. 4 represent the transport of the structural fiber elements and prepregs on the carrier net. Functioning of the units of the novel installation separately identified above will be explained as follows:

The reinforcement fibers are unwound from the rolls in the unwinding unit for the fibers and are moved to the cutting-to-size unit. An intermediate storage device sees to it that rolls can be changed while the machine is running.

In the cutting-to-size unit the reinforcement fibers, for example carbon or aramide fibers, are cut by a cutting device into structural fiber elements of defined contours. The type of the cutting device is unimportant for the invention. Cutting knives, laser or plasma cutters are preferably used, because the employment of water jet cutters would result in residual moisture in the fibers, which would first have to be evaporated prior to further processing. The cut structural fiber elements can be freed of fiber residue by means of ionized air, for example.

The unwinding units for the carrier net corresponds in principle to the unwinding unit of a conventional impregnating installation for the fiber web.

The latter is impregnated in the unit for pre-impregnating the carrier net with a rapidly curing, highly viscous adhesive resin which, however, remains permanently elastic after curing, for example an epoxy resin or polyurethane resin. Because of the small forces which the carrier net has to withstand (approximately 50 N/5 cm), the carrier net can be produced as a wide-mesh net of little yarn thickness, so that it covers the structural fibers elements only slightly, for example 5% at most (approximately 3% to 4%), which does not interfere with the later bonding of the prepregs.

At the location where the structural fiber elements are brought together with the carrier net, the structural fiber elements are applied by rolling to the carrier net, which has been impregnated with adhesive resin and is run through continuously or in steps, and are moved on.

The adhesive resin, which fixes the structural fiber elements in place, is at least partially cured in the drying unit for the carrier net. It is of no importance for the invention whether this takes place by means of heat or, for example, by UV radiation. If UV radiation is used, the subsequent cooling unit for the carrier net is superfluous, in which in the exemplary embodiment the carrier net with the glued-on structural fiber elements is cooled back down to room temperature, so that normal conditions for the main impregnating process are created.

Deviating from this exemplary embodiment, the structural fiber elements could also be fastened on the carrier net by means of yarn loops or clamps, so that pre-impregnating and drying of the net is omitted. Depending on the course of the carrier net and the implementation of the impregnating process, for example in case of a horizontal course and impregnation by means of a pouring or spraying process, it could even be sufficient to place the structural fiber elements on the carrier net without fixing them in place. This possibility could also exist if impregnation is performed in an immersion bath and if in this area the structural fiber elements are pressed against the carrier net by a web of netting, arranged above the carrier net and driven at the same speed and rotating endlessly.

The impregnating unit for the prepregs, the drying unit for the prepregs contained in the exemplary embodiment, the cooling unit for the prepregs and the winding unit correspond to the units of a conventional installation. Since less material is passed through the drying unit at the same passing speed of the structural fiber elements as in a conventional installation, it can normally be operated with less power. The impregnating unit preferably is a bath containing epoxy resin or polyurethane resin, which has been set at low viscosity, for example by means of a solvent, and through which the carrier net, together with the structural fiber elements fixed in place thereon, is pulled. Immediately following this it is possible to strip excessive resin from the structural fiber elements, for example by stripping or pressure rollers, in order to set a definite proportion of the fiber and resin content of the prepregs.

Although the prepregs produced in accordance with the invention are individual parts, which have been shaped from the beginning to have defined contours, they can be combined into a roll in the winding unit by means of the carrier net in a simple way and in a small space, and can be stored and transported in this form. Separation from the carrier net usefully takes place later at the location of further processing. It can take place, for example, by cutting out, burning out or in other suitable ways. In individual cases it is possible to achieve by special means, for example by spacers between the structural fiber elements and the carrier net, and/or the selection of a material for the carrier net, which is not wetted by the resin, that the prepregs can be removed not only from the area of the carrier net surrounding them, but also from the area which they have covered.

FIG. 3 represents in a perspective lateral view the transport of differently shaped prepregs 10 on the carrier net 12 in the area between the drying unit and the winding unit.

FIG. 4 is a simplified view from above on the production installation. Here, the unwinding unit for the carrier net is identified by 14, and the unit in which the structural fiber elements 16 of the respectively desired shape are individually brought together with the carrier net 12, by the reference numeral 18. The structural fiber elements 16, which have for example been glued together with the carrier net 12, then pass through the impregnating unit 20, so that downstream of the latter a structural fiber element 20 appears, which rests on the carrier net 12 and is soaked in resin. This is subsequently dried in the drying unit 24 and is cooled, if required, so that thereafter the finished prepregs 10 can be transported to the winding unit 26 and can be rolled up there together with the carrier net 12. The production units which had not been mentioned above, but are represented in FIG. 2, are not represented in FIG. 4 for the sake of clarity.

1. A method for producing prepregs consisting of synthetic resin and reinforcement fibers, having defined contours, characterized in that structural fiber elements, consisting of at least one layer of reinforcement fibers, are produced with contours corresponding to the contours of the prepregs to be produced, that the structural fiber elements are placed on a carrier net and are saturated with a resin, which is subsequently cured to the degree of strength required for prepregs, and that finally the prepregs obtained and having the predetermined contours, together with the areas of the carrier net respectively covered by them, are separated from the portion of the carrier net surrounding them.

2. The method in accordance with claim 1, characterized in that prior to placing the structural fiber elements on it, the carrier net is pre-impregnated with a resin which is at least partially cured after the structural fiber elements have been placed on and pressed against it, so that they are glued together with the carrier net.

3. The method in accordance with claim 2, characterized in that an adhesive resin, for example an epoxy resin or a polyurethane resin, which can be rapidly cured and is permanently elastic after curing, is employed for pre-impregnating the carrier net.

4. The method in accordance with claim 1, characterized in that for impregnating the structural fiber elements a resin, which has been set to have low viscosity by means of a solvent, for example an epoxy resin or a polyurethane resin, is employed and, following the saturation of the structural fiber elements, is dried by heating and evaporating the solvent and is subsequently cooled.

5. The method in accordance with claim 1, characterized in that the reinforcement fibers and the carrier net are drawn off supply rolls continuously or in steps, and pre-impregnation of the carrier net, as well as the impregnation of the structural fiber elements, takes place continuously in the course of drawing the carrier net off its supply roll or out of an intermediate storage device.

6. The method in accordance with claim 1, characterized in that the structural fiber elements are cut out of a web of fibers drawn off a supply roll by means of a cutting knife or a beam cutting tool.

7. The method in accordance with claim 1, characterized in that the structural fiber elements are freed of fiber residue by means of ionized air.

8. The method in accordance with claim 1, characterized in that, for saturating the structural fiber elements with resin, the carrier net is drawn through a bath containing the resin.

9. The method in accordance with claim 1, characterized in that a carrier net is used, whose mesh width and fiber thickness are of such size that the structural fiber elements are covered to at most 5%.

10. The method in accordance with claim 1, characterized in that the carrier net with the prepregs held thereon adhesively is rolled up for storage and transport of the latter to the location where they are cut out of the carrier net and further processed.
